(19) United States
(12) Patent Application Publication
(10) Pub. No.: US 2024/0105930 A1
(43) Pub. Date: Mar. 28, 2024

(54) TRANSITION METAL LAYERED OXIDES, POSITIVE ELECTRODE MATERIAL, AND SODIUM-ION BATTERY

(71) Applicant: National Tsing Hua University, Hsinchu City (TW)

(72) Inventors: Jin-Wei Kang, Hsinchu City (TW); Han-Yi Chen, Hsinchu City (TW)

(73) Assignee: National Tsing Hua University, Hsinchu City (TW)

(21) Appl. No.: 17/992,898

(22) Filed: Nov. 22, 2022

(30) Foreign Application Priority Data
Sep. 27, 2022 (TW) 111136487

(51) Int. Cl. H01M 4/505; C01G 45/12; H01M 4/131; H01M 4/36; H01M 10/054

(52) U.S. Cl. CPC H01M 4/505; C01G 45/1228; H01M 4/131; H01M 4/366; H01M 10/054; H01M 2004/028

(57) ABSTRACT

A transition metal layered oxide is a P2 type transition metal layered oxide which is represented by following formula (1).

Na_{0.67-2x}M1ₓMgₐCu_{b}Mn_{1-a-b}O₂ (1)

In the formula (1), M1 is selected from a group consisting of calcium (Ca), potassium (K), magnesium (Mg), and lithium (Li), 0.01≤a+b≤0.5, 0.01≤a≤0.5, 0.01≤b≤0.5, and 0≤x≤0.2. A positive electrode material of a sodium-ion battery includes the above transition metal layered oxide.

### CROSS-REFERENCE TO RELATED APPLICATION

This application claims the priority benefit of Taiwan application serial no. 111136487, filed on Sep. 27, 2022. The entirety of the above-mentioned patent application is hereby incorporated by reference herein and made a part of this specification.

### BACKGROUND

### Technical Field

The disclosure relates to a layered oxide technology, and more particularly, to a transition metal layered oxide and an application thereof to a positive electrode material and a sodium-ion battery including the positive electrode material.

### Description of Related Art

With the rapid development of fields such as renewable energy and electric vehicles, the demand for energy storage systems with high energy density and power density is increasing.

Sodium-ion batteries have the advantages of high energy density, low self-discharge, fast charge and discharge, and long cycle life, and the production cost thereof is lower than that of lithium-ion batteries. Therefore, sodium-ion batteries have cost advantages in energy storage apparatuses. In addition, in order to improve the performance of the sodium-ion batteries, the development of positive electrode materials is crucial to increase electrochemical properties of the sodium-ion batteries.

However, the energy density of the conventional layered oxide is affected by the weight and volume of sodium ions, so that the overall capacity is lower than that of the conventional lithium-ion batteries. If the capacity is to be increased, it will adversely affect the structure, resulting in poor cyclic stability.

### SUMMARY

The disclosure provides a transition metal layered oxide, which is suitable for a positive electrode material of a sodium-ion battery.

The disclosure further provides a positive electrode material of a sodium-ion battery, which has a stable structure to increase cyclic stability and reduce potential hysteresis.

The disclosure further provides a sodium-ion battery containing the positive electrode material.

The transition metal layered oxide in the disclosure is a P2 type transition metal layered oxide represented by the following formula (1).

Na_{0.67-2x}M1ₓMgₐCu_{b}Mn_{1-a-b}O₂ (1)

In the formula (1), M1 is selected from a group consisting of calcium (Ca), potassium (K), magnesium (Mg), and lithium (Li), 0.01≤a+b≤0.5, 0.01≤a≤0.5, 0.01≤b≤0.5, and 0≤x≤0.2.

In an embodiment of the disclosure, the P2 type transition metal layered oxide includes a transition metal layer and an alkaline metal layer, and if M1 is Mg, M1 is in the alkaline metal layer.

In an embodiment of the disclosure, M1 is Ca.

In an embodiment of the disclosure, a+b is less than or equal to 0.33.

In an embodiment of the disclosure, the P2 type transition metal layered oxide includes Na_{0.61}Ca_{0.03} Mg_{2/9}Cu_{1/9}Mn_{2/3}O₂, Na_{0.65}Ca_{0.01} Mg_{2/9}Cu_{1/9}Mn_{2/3}O₂, or Na_{0.57}Ca_{0.05} Mg_{2/9}Cu_{1/9}Mn_{2/3} O₂.

In an embodiment of the disclosure, a surface of the P2 type transition metal layered oxide may be coated with carbon.

In an embodiment of the disclosure, the P2 type transition metal layered oxide is synthesized by a sol-gel method, a co-precipitation method, a solid-phase sintering method, or a hydrothermal method.

The positive electrode material of the sodium-ion battery in the disclosure includes the transition metal layered oxide, a conductive agent, and a binder.

In another embodiment of the disclosure, a content of the transition metal layered oxide is 70 wt. % to 95 wt. %. A content of the conductive agent is 2 wt. % to 15 wt. %. A content of the binder is 2 wt. %.% to 15 wt. %.

The sodium-ion battery in the disclosure includes a positive electrode, a negative electrode, a separator, and an electrolyte solution. The positive electrode contains the positive electrode material, and the separator is between the positive electrode and the negative electrode.

Based on the above, in the disclosure, the P2 type transition metal layered oxide doped with the metal element is used as the positive electrode material, and the doped metal element have a specific molar ratio and an atomic size that may enter the alkaline metal layer. Therefore, it may not only improve the battery capacity but also have better structural stability, so as to improve the cyclic stability of the battery at the same time.

In order for the aforementioned features and advantages of the disclosure to be more comprehensible, embodiments accompanied with drawings are described in detail below.

### BRIEF DESCRIPTION OF THE DRAWINGS

FIG. 1 is a schematic structural diagram of a transition metal layered oxide according to an embodiment of the disclosure.

FIG. 2 is an X-ray diffraction (XRD) pattern of a product of Preparation Example 1.

FIG. 3 is a scanning electron microscope (SEM) image of the product of Preparation Example 1.

FIG. 4 is an exploded view of a coin cell used in an experiment of the disclosure.

FIG. 5 is a diagram of constant-current charge and discharge of a half battery containing an electrode of Preparation Example 1.

FIG. 6 is a diagram of a charge and discharge cycle test of the half battery containing the electrode of Preparation Example 1.

FIG. 7 is a diagram of the charge and discharge cycle test of the half battery containing the electrode of Preparation Example 1 at different charge and discharge rates.

FIG. 8 is an XRD pattern of a product of Preparation Example 2.

FIG. 9 is an SEM image of the product of Preparation Example 2.

FIG. 10 is a diagram of constant-current charge and discharge of a half battery containing an electrode of Preparation Example 2.

FIG. 11 is a diagram of a charge and discharge cycle test of the half battery containing the electrode of Preparation Example 2.

FIG. 12 is a diagram of the charge and discharge cycle test of the half battery containing the electrode of Preparation Example 2 at different charge and discharge rates.

FIG. 13 is a diagram of a charge and discharge cycle test of a half battery containing an electrode of Na_{0.61}Ca_{0.03}Mg_{2/9}Cu_{1/9}Mn_{2/3}O₂.

FIG. 14 is a diagram of the charge and discharge cycle test of the half battery containing the electrode of Na_{0.61}Ca_{0.03}Mg_{2/9}Cu_{1/9}Mn_{2/3}O₂ at different charge and discharge rates.

FIG. 15 is a diagram of a charge and discharge cycle test of a sodium-ion full cell containing the electrode of Na_{0.61}Ca_{0.03}Mg_{2/9}Cu_{1/9}Mn_{2/3}O₂.

FIG. 16 is a diagram of charge and discharge of the sodium-ion full cell containing the electrode of Na_{0.61}Ca_{0.03}Mg_{2/9}Cu_{1/9}Mn_{2/3}O₂ at different rates.

FIG. 17 is a diagram of the charge and discharge cycle test of the sodium-ion full cell containing the electrode of Na_{0.61}Ca_{0.03}Mg_{2/9}Cu_{1/9}Mn_{2/3}O₂ at different charge and discharge rates.

### DETAILED DESCRIPTION OF DISCLOSED EMBODIMENTS

Hereinafter, many different embodiments are provided for implementing different features of the disclosure. However, the embodiments are merely exemplary, and are not intended to limit the scope and application of the disclosure.

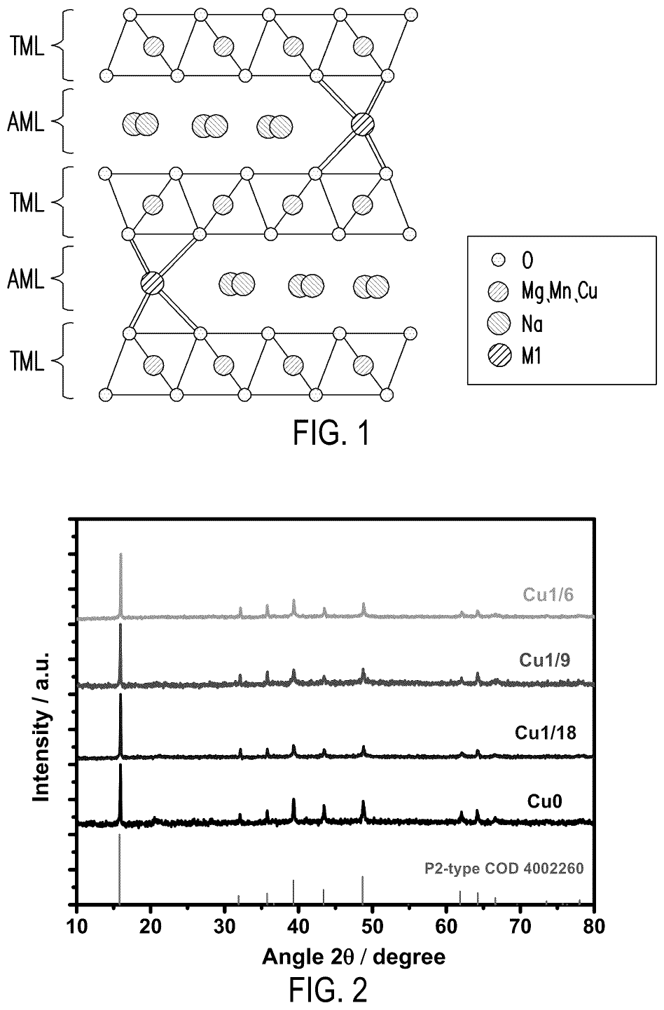

FIG. 1 is a schematic structural diagram of a transition metal layered oxide according to an embodiment of the disclosure.

First, the transition metal layered oxide in this embodiment is a P2 type transition metal layered oxide represented by the following formula (1).

Na_{0.67-2x}M1ₓMgₐCu_{b}Mn_{1-a-b}O₂ (1)

In the formula (1), M1 is selected from a group consisting of calcium (Ca), potassium (K), magnesium (Mg), and lithium (Li), 0.01≤a+b≤0.5, 0.01≤a≤0.5, 0.01≤b≤0.5, and 0≤x≤0.2.

Referring to FIG. 1, the P2 type transition metal layered oxide includes a transition metal layer TML and an alkaline metal layer AML.

In the P2 type transition metal layered oxide in the disclosure, oxygen (O) is low in electronegativity and has an effect of structural stability; copper (Cu) is also low in the electronegativity and has the effect of structural stability; magnesium (Mg) has a higher electronegativity than 0, which is used to induce anions to generate an oxidation-reduction reaction, so that the anions contribute capacity; metal elements such as Ca, K, Mg, and Li with similar sizes are selected for M1, which is beneficial to for sodium (Na) to enter and exit without structural reduction. However, M1 may form an impurity phase and restrict the entry and exit of Na. Therefore, M1 in the P2 type transition metal layered oxide in the disclosure is required to be limited within a specific molar ratio (content).

In addition, M1 may be Mg. Since M1 is in the alkaline metal layer AML, Mg here and Mg in the transition metal layer TML have different effects on the overall P2 type transition metal layered oxide.

In an embodiment, M1 is Ca.

In an embodiment, a+b in the formula (1) is equal to 0.33. In another embodiment, a+b in the formula (1) is less than 0.33.

In an embodiment of the disclosure, the P2 type transition metal layered oxide may be but not limited to Na_{0.61}Ca_{0.03}Mg_{2/9}Cu_{1/9}Mn_{2/3}O₂, Na_{0.65}Ca_{0.01}Mg_{2/9}Cu_{1/9}Mn_{2/3}O₂, or Na_{0.57}Ca_{0.05} Mg_{2/9}Cu_{1/9}Mn_{2/3}O₂. In a preferred embodiment, the P2 type transition metal layered oxide is Na_{0.61}Ca_{0.03}Mg_{2/9}Cu_{1/9}Mn_{2/3}O₂.

In this embodiment, the P2 type transition metal layered oxide has relatively good rate performance and structural stability, and is easy to prepare. Adding Cu and Mg to the transition metal layer TML may achieve a lower voltage hysteresis effect, enhance the stability of oxygen in the structure, and improve the rate performance. At the same time, adding M1 to the alkaline metal layer AML may further obtain the good structural stability, high capacity, and limited phase transition.

In an embodiment of disclosure, the P2-type transition metal layered oxide may be synthesized by a sol-gel method, and the prepared transition metal layered oxide has uniform distribution of elements and has a layered structure. However, the disclosure is not limited thereto, and the P2 type transition metal layered oxide may also be synthesized by a co-precipitation method, a solid-phase sintering method, a hydrothermal method, or the like.

In another embodiment of the disclosure, a positive electrode material includes the transition metal layered oxide, a conductive agent, and a binder. In the positive electrode material, a content of the transition metal layered oxide is, for example, 70 wt. % to 95 wt. %, and may be 75 wt. % to 85 wt. %. A content of the conductive agent is, for example, 20 wt. % or less, and may be 2 wt. % to 15 wt. %. A content of the binder is, for example, 20 wt. % or less, and may be 2 wt. % to 15 wt. %.

The conductive agent may be but not limited to graphite, carbon black, carbon fiber, carbon nanotubes, acetylene black, meso carbon micro beads (MCMB), graphene, or a combination thereof.

The binder may be but not limited to styrene-butadiene rubber latex (SBR), carboxymethyl cellulose (CMC), polyvinylidene difluoride (PVDF), polyimide, acrylic resins, butyral resins, polytetrafluoroethylene latex (PTFE), polyacrylate (PAA), or a combination thereof.

In still another embodiment of the disclosure, a sodium-ion battery basically includes a positive electrode, a negative electrode, a separator, and an electrolyte solution. The positive electrode contains the positive electrode material, and the separator is between the positive electrode and the negative electrode.

Hereinafter, experiments are given to verify the implementation effect of the disclosure, but the disclosure is not limited to the following contents.

### Preparation Example 1: Na_{0.67}Mg_{1/3-x}CuₓMn_{2/3}O₂ was Synthesized by the Sol-Gel Method

First, MgN₂O₆·6H₂O, CuN₂O₆·2.5H₂O, and MnN₂O₆·4H₂O prepared according to molar ratios in Table 1 below were used as precursors. Next, all the precursors were added to deionized water of 15 ml, mixed, and then added with a chelating agent (a solution of citric acid and ethylene glycol in a molar ratio of 1:4 in the deionized water of 15 ml) to form a hydrogel. After being dried, NaNO₃ was added to be mixed and ground into powder, and then dehydration and desalting were performed. Finally, high-temperature sintering was performed at 850° C. for 10 hours to obtain Na_{0.67}Mg_{1/3-x}CuₓMn_{2/3}O₂ powder.

TABLE 1

| x | Sample name |
|---|---|
| 0 | Cu0 |
| 1/18 | Cu 1/18 |
| 1/9 | Cu 1/9 |
| ⅙ | Cu⅙ |

<Structural Analysis>

1. An X-ray diffraction (XRD) analysis is performed on a product of Preparation Example 1, and results thereof are shown in FIG. 2. According to FIG. 2, the product synthesized by the sol-gel method is indeed the P2 type transition metal layered oxide.

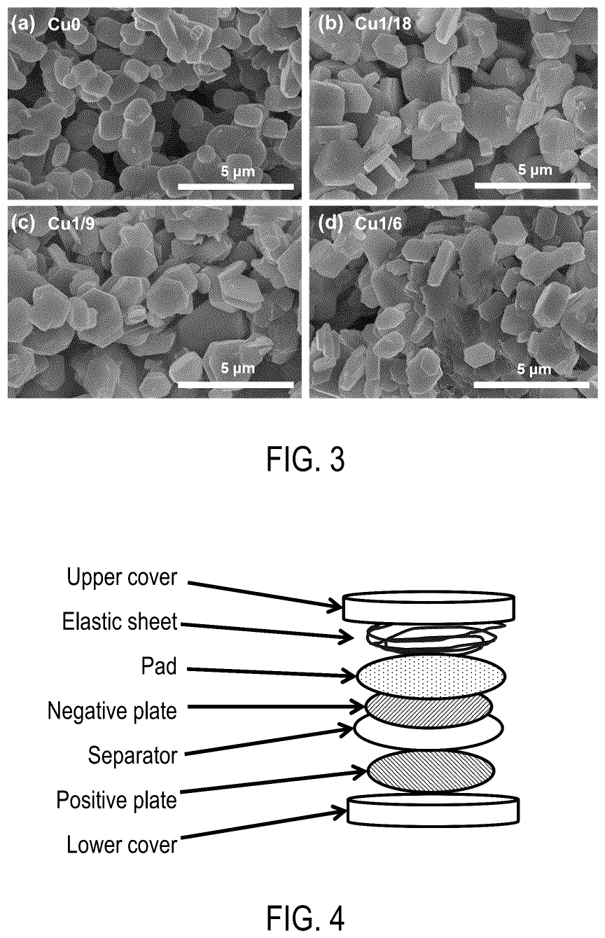

2. A SEM analysis is performed on the product of Preparation Example 1, and results thereof are shown in FIG. 3. According to FIG. 3, the product synthesized by the sol-gel method has a flake-shaped structure and is uniformly dispersed without other impurity phases or particles, and an average particle size is about 1 μm to 3 μm.

<Fabrication of Coin Cell>

First, the product of Preparation Example 1 was mixed and ground with carbon black, and then added to a PVDF solution (PVDF of 6 wt. % dissolved in an NMP solvent) to be mixed. A weight ratio of the product of Preparation Example 1, carbon black, and PVDF is 80:10:10.

The above mixture was coated on aluminum foil (a thickness of 20 μm) using a doctor blade, and was dried (80° C.), rolled, and cut into pieces to obtain electrode plates containing the product of Preparation Example 1, respectively.

The obtained electrode plates and other components were formed into the coin cell as shown in FIG. 4. The separator is glassy fiber (Whatman GF/C). A positive plate is the electrode plate, and a negative plate is sodium. The electrolyte solution is 1 M NaClO₄ EC+PC 1:1 (volume ratio).

<Electrochemical Analysis>

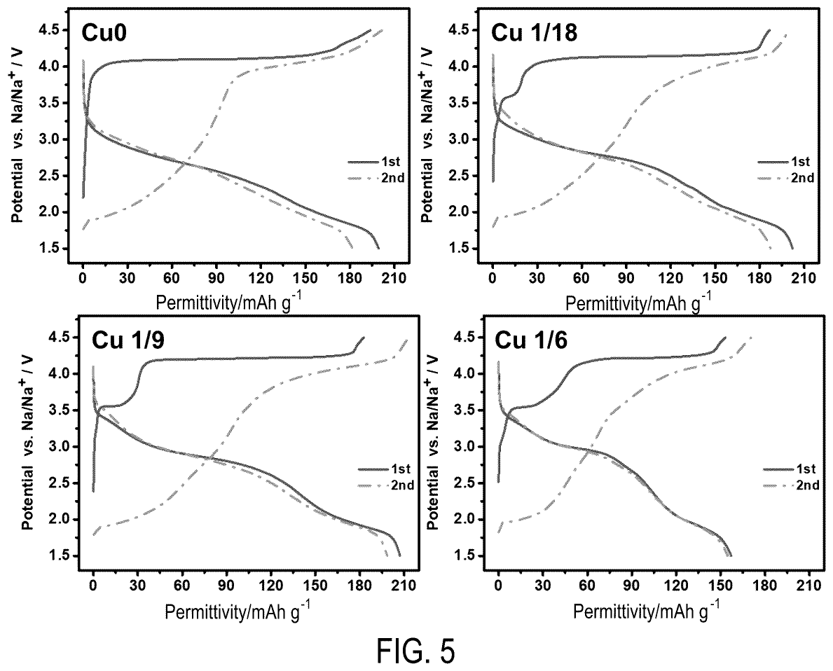

A constant-current charge and discharge test is performed using the coin cell prepared with different positive plates, and a diagram of constant-current charge and discharge of FIG. 5 is obtained. According to FIG. 5, at a constant current of 10 mAh g⁻¹, for the electrode plate formed by the P2 type transition metal layered oxide Na_{0.67}Mg_{1/3-x}CuₓMn_{2/3}O₂ without copper and respectively containing different proportions of copper, with different additions of copper elements, a highest charge and discharge platform of Cu1/9 is obtained in a voltage range from 1.5 V to 4.5 V vs Na/Na+, which is thus used as a benchmark in the subsequent experiments. In addition, according to FIG. 5, both Cu1/18 and Cu1/6 also show better reaction potential and capacity performance than those without copper (Cu0).

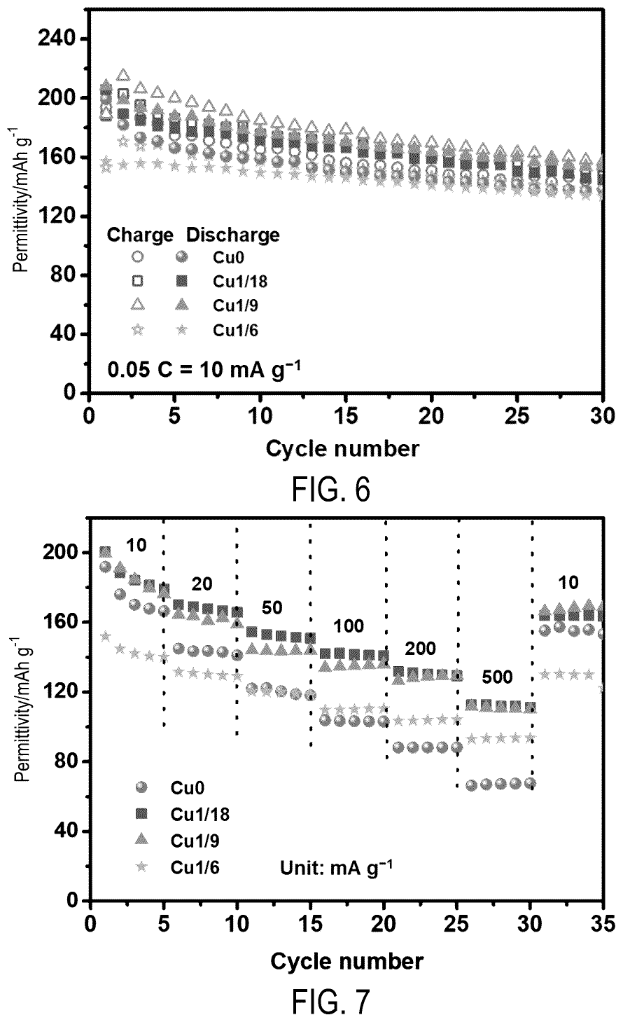

Then, in the voltage range from 1.5 V to 4.5 V vs Na/Na⁺ and at a current density of 10 mA g⁻¹, changes in cycle numbers and the capacity are recorded, and results thereof are obtained in FIG. 6.

According to FIG. 6, the coin cell with the electrode plate formed by Cu1/9 (Na_{0.67}Mg_{2/9}Cu_{1/9}Mn_{2/3}O₂) has the best cyclic stability, and it still maintains relatively high capacity after 100 cycles.

Next, at current densities of 10 mA g⁻¹ (0.05 C), 20 mA g⁻¹ (0.1 C), 50 mA g⁻¹ (0.25 C), 100 mA g⁻¹ (0.5 C), 200 mA g⁻¹ (1 C), and 500 mA g⁻¹ (2.5 C), the constant-current charge and discharge test is performed, and results thereof are shown in FIG. 7.

According to FIG. 7, the coin cell with the electrode plate formed by Cu1/9 (Na_{0.67}Mg_{2/9}Cu_{1/9}Mn_{2/3}O₂) also has the best rate performance at different charge and discharge rates.

### Preparation Example 2: Na_{0.67-2x}CaₓMg_{2/9}Cu_{1/9}Mn_{2/3}O₂ was Synthesized by the Sol-Gel Method

First, MgN₂O₆·6H₂O, CuN₂O₆·2.5H₂O, MnN₂O₆·4H₂O, and CaN₂O₆·4H₂O prepared according to the molar ratios in Table 2 below were used as the precursors. Next, all the precursors were added to the deionized water of 15 ml, mixed, and then added with the chelating agent (the solution of citric acid and ethylene glycol in the molar ratio of 1:4 in the deionized water of 15 ml) to form the hydrogel. After being dried, NaNO₃ was added to be mixed and ground into the powder, and then dehydration and desalting were performed. Finally, high-temperature sintering was performed at 850° C. for 10 hours to obtain the Na_{0.67-2x}CaₓMg_{2/9}Cu_{1/9}Mn_{2/3}O₂ powder. That is to say, except for the addition of the precursors, a manufacturing process of Preparation Example 2 is actually the same as that of Preparation Example 1.

TABLE 2

| x | Sample name |
|---|---|
| 0 | Ca0 |
| 0.01 | Ca0.01 |
| 0.03 | Ca0.03 |
| 0.05 | Ca0.05 |

<Structural Analysis>

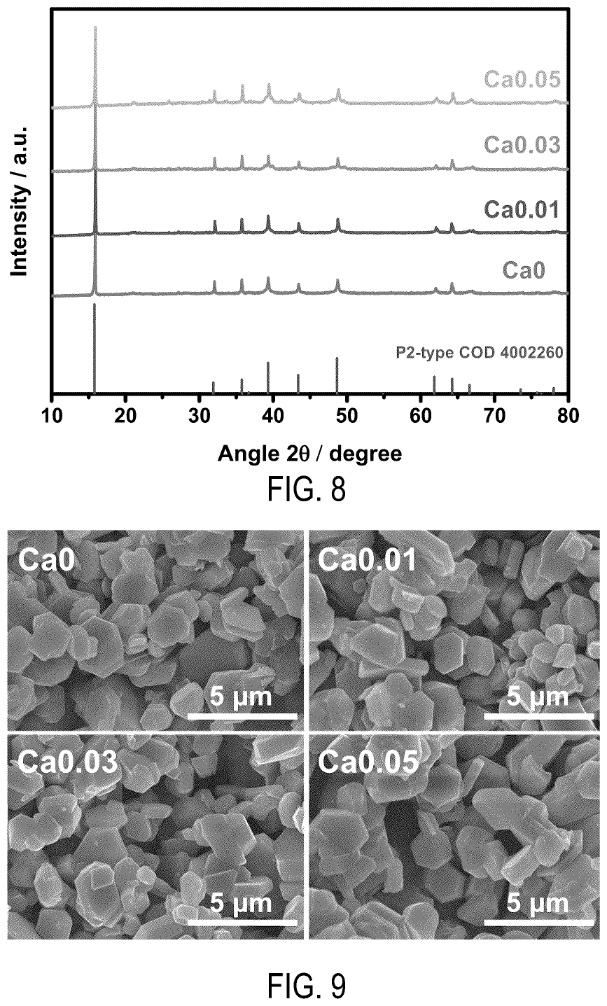

1. The X-ray diffraction (XRD) analysis is performed on a product of Preparation Example 2, and results thereof are shown in FIG. 8. According to FIG. 8, the product synthesized by the sol-gel method is indeed the P2 type transition metal layered oxide.

2. The SEM analysis is performed on the product of Preparation Example 2, and results thereof are shown in FIG. 9. According to FIG. 9, the transition metal layered oxide in the disclosure synthesized by the sol-gel method has the flake-shaped structure and is uniformly dispersed, and an average particle size is about 1 μm to 5 μm.

<Electrochemical Analysis>

According to the above method of fabricating the product of Preparation Example 1 into the electrode plate and then forming the coin cell as shown in FIG. 4, an electrode plate and a coin cell containing the product of Preparation Example 2 were also fabricated.

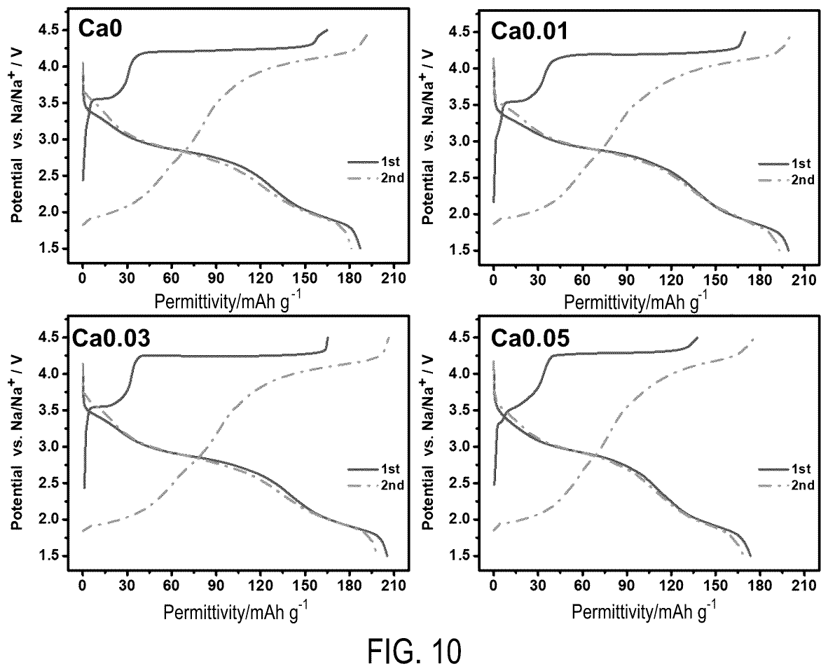

The charge and discharge test at a constant current of 20 mAh g⁻¹ is performed using the coin cell with different positive plates, and a diagram of constant-current charge and discharge of FIG. 10 is obtained. According to FIG. 10, the addition of Ca in the disclosure does not affect the charging and discharging effect of Na.

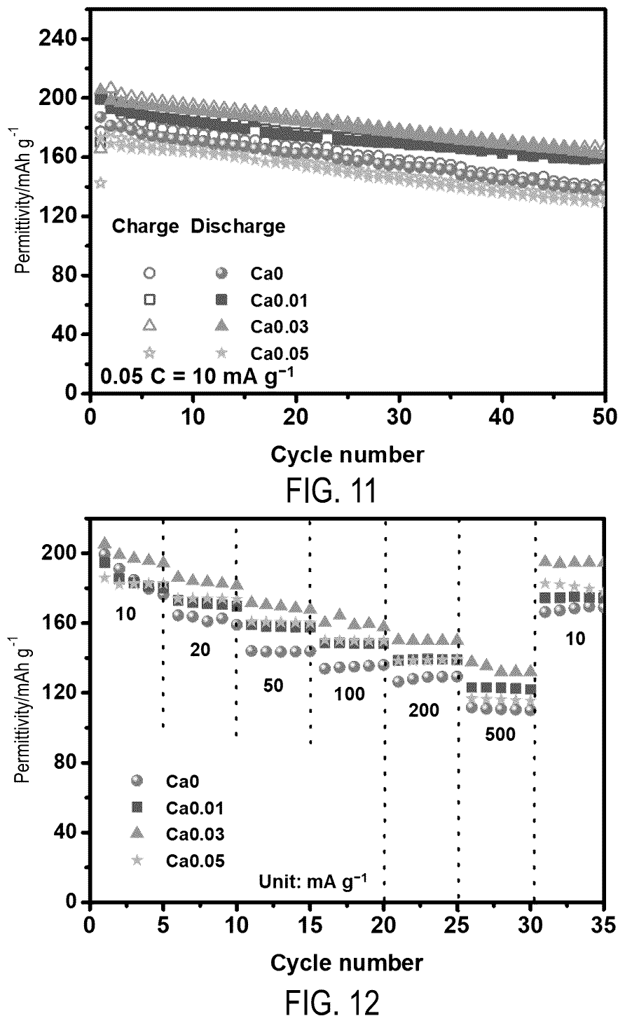

Then, in the voltage range from 1.5 V to 4.5 V vs Na/Na⁺ and at a current density of 20 mA g⁻¹, changes in the cycle numbers and the capacity are recorded, and results thereof are obtained in FIG. 11.

According to FIG. 11, the coin cell with the electrode plate fabricated in Preparation Example 2 has the excellent cyclic stability. In particular, Ca0.03 (Na_{0.61}Ca_{0.03}Mg_{2/9}Cu_{1/9}Mn_{2/3}O₂) has the best cyclic stability, and it still maintains relatively high capacity after 100 cycles.

Next, at current densities of 10 mA g⁻¹ (0.05 C), 20 mA g⁻¹ (0.1 C), 50 mA g⁻¹ (0.25 C), 100 mA g⁻¹ (0.5 C), 200 mA g⁻¹ (1 C), and 500 mA g⁻¹ (2.5 C), the constant-current charge and discharge test is performed, and results thereof are shown in FIG. 12. According to FIG. 12, at different charge and discharge rates, the product containing Ca in Preparation Example 2 has better rate performance than the product without calcium.

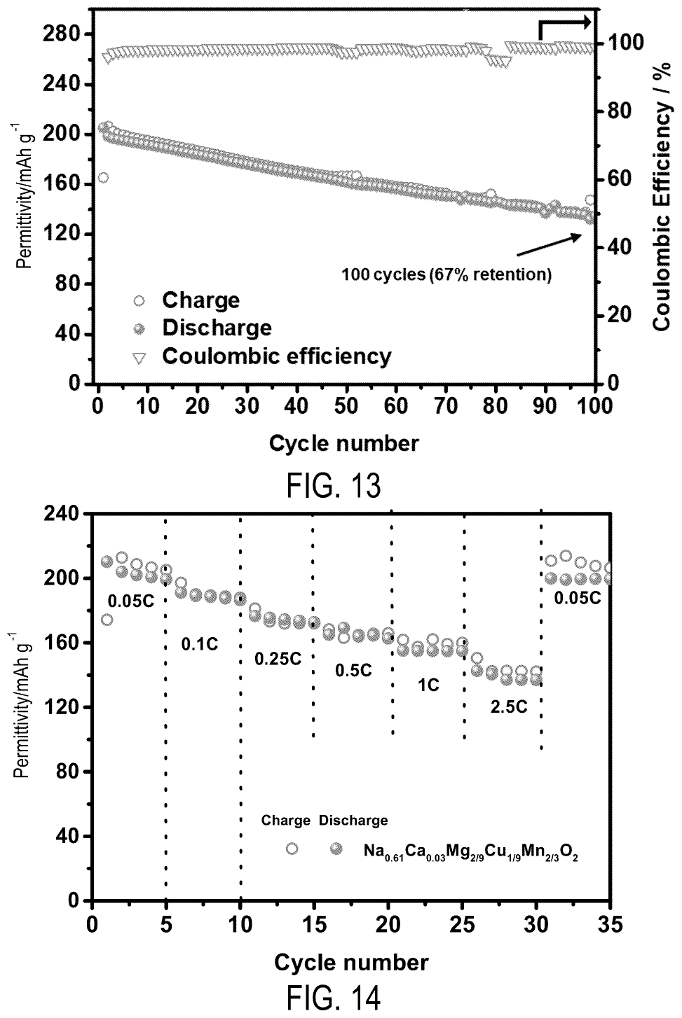

In addition, the charge and discharge cyclic stability (FIG. 13) and the rate performance (FIG. 14) of the coin cell with the electrode plate formed by Na_{0.61}Ca_{0.03}Mg_{2/9}Cu_{1/9}Mn_{2/3}O₂ are observed separately. It may be obtained that after 100 cycles at a charge and discharge rate of 0.1 C, the coin cell still maintains a capacity retention rate of 67%.

<Analysis of Full Cell>

A sodium-ion full cell is formed by the positive plate formed by the positive electrode material containing Na_{0.61}Ca_{0.03}Mg_{2/9}Cu_{1/9}Mn_{2/3}O₂ and a hard carbon negative electrode, and the rest of components are the same as those used in the coin cell.

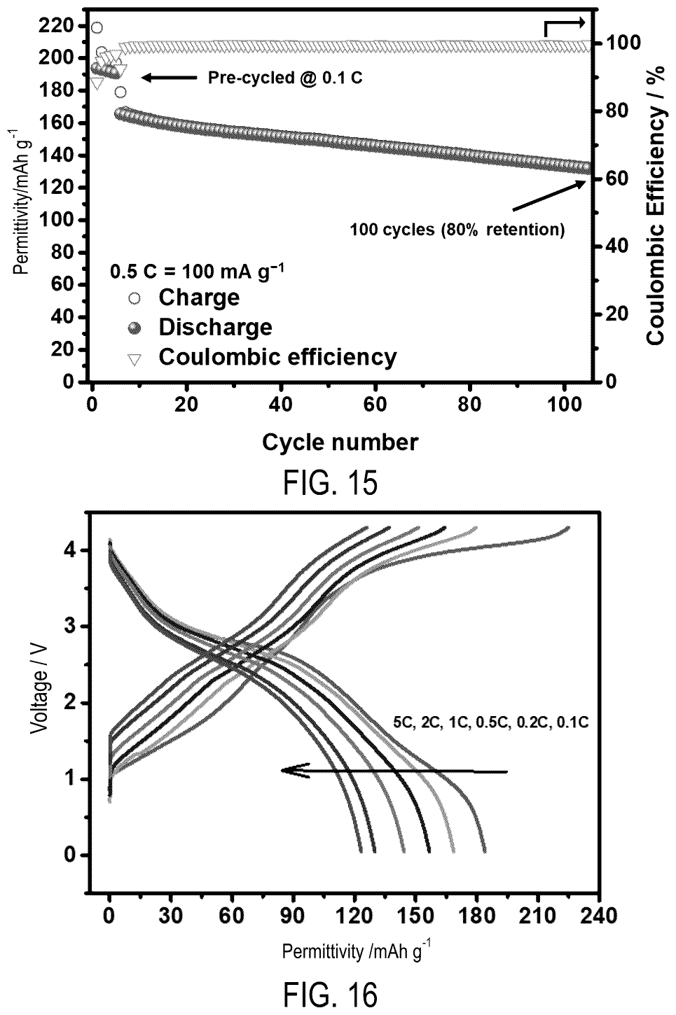

Then, changes in cycle numbers and capacity of the sodium-ion full cell are observed at a constant current of 100 mA g⁻¹ (0.5 C), and FIG. 15 is obtained.

According to FIG. 15, an initial discharge capacity of the sodium-ion full cell is 193.7 mAh g⁻¹, and it still maintains the capacity retention rate of 80% after 100 cycles.

Then, in a voltage range from 0.5 V to 4.3 V, at 20 mA g-1 (0.1 C), the constant-current charge and discharge test is performed at current densities of 20 mA g⁻¹ (0.1 C), 40 mA g⁻¹ (0.2 C), 100 mA g⁻¹ (0.5 C), 200 mA g⁻¹ (1 C), 400 mA g⁻¹ (2C), and 1000 mA g⁻¹ (5 C) (according to a weight of the positive electrode material), and FIG. 16 is obtained.

According to FIG. 16, the capacity at different charge and discharge rates (0.1 C to 5 C) are 183.8 mAh g⁻¹, 168.5 mAh g⁻¹, 156.7 mAh g⁻¹, 144.2 mAh g⁻¹, 130.0 mAh g⁻¹, and 123.3 mAh g⁻¹, respectively, indicating that the product of Na_{0.61}Ca_{0.03}Mg_{2/9}Cu_{1/9}Mn_{2/3}O₂ in the disclosure has excellent potential as the positive electrode of the sodium-ion battery.

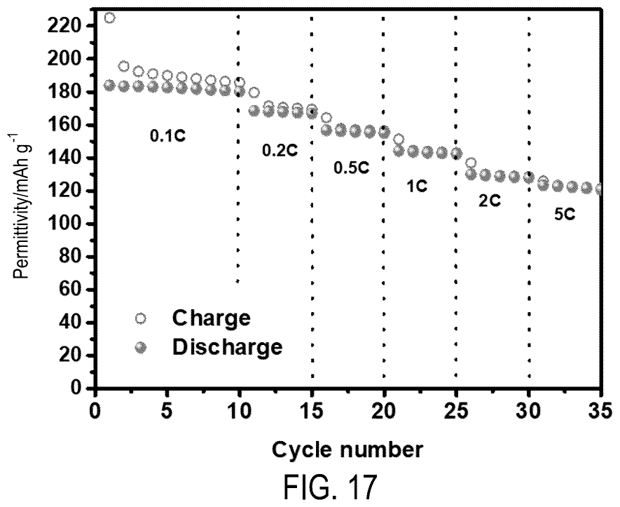

Next, the rate performance of the sodium-ion full cell is observed separately (FIG. 17), and it may be obtained that it further has a capacity of up to 119 mAh g⁻¹ at a charge and discharge rate of 5 C. In addition, an average voltage of the sodium-ion full cell is measured to be 2.29 V, and an energy density is measured to be 250.7 Wh kg⁻¹.

Based on the above, in the disclosure, the P2 type transition metal layered oxide is doped with the metal element having the specific molar ratio and the atomic size that may enter the alkaline metal layer, thereby improving the battery capacity and strengthening the structural stability. Therefore, the cyclic stability of the sodium-ion battery is improved at the same time.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A transition metal layered oxide, which is a P2 type transition metal layered oxide represented by the following formula (1):
Na_{0.67-2x}M1ₓMgₐCu_{b}Mn_{1-a-b}O₂ (1)
in the formula (1), M1 is selected from a group consisting of calcium (Ca), potassium (K), magnesium (Mg), and lithium (Li), 0.01≤a+b≤0.5, 0.01≤a≤0.5, 0.01≤b≤0.5, and 0≤x≤0.2.

2. The transition metal layered oxide according to claim 1, wherein the P2 type transition metal layered oxide comprises a transition metal layer and an alkaline metal layer, and if M1 is Mg, M1 is in the alkaline metal layer.

3. The transition metal layered oxide according to claim 1, wherein M1 is Ca.

4. The transition metal layered oxide according to claim 1, wherein a+b is less than or equal to 0.33.

5. The transition metal layered oxide according to claim 1, wherein the P2 type transition metal layered oxide comprises Na_{0.61}Ca_{0.03}Mg_{2/9}Cu_{1/9}Mn_{2/3}O₂, Na_{0.65}Ca_{0.01}Mg_{2/9}Cu_{1/9}Mn_{2/3}O₂, or Na_{0.57}Ca_{0.05} Mg_{2/9}Cu_{1/9}Mn_{2/3}O₂.

6. The transition metal layered oxide according to claim 1, wherein the P2 type transition metal layered oxide is synthesized by a sol-gel method, a co-precipitation method, a solid-phase sintering method, or a hydrothermal method.

7. A positive electrode material of a sodium-ion battery, comprising:
the transition metal layered oxide according to claim 1;
a conductive agent; and
a binder.

8. The positive electrode material of the sodium-ion battery according to claim 7, wherein a content of the transition metal layered oxide is 70 wt. % to 95 wt. %, a content of the conductive agent is 2 wt. % to 15 wt. %, and a content of the binder is 2 wt. %.% to 15 wt. %.

9. A sodium-ion battery, comprising:
a positive electrode, containing the positive electrode material according to claim 7;
a negative electrode;
a separator between the positive electrode and the negative electrode; and
an electrolyte solution.
